(19) United States
(12) Patent Application Publication
(10) Pub. No.: US 2012/0242081 A1
(43) Pub. Date: Sep. 27, 2012

(54) Pipe Connecting System

(75) Inventors: Steven Keays, Calgary (CA); Ronald Chune, Calgary (CA); Travis Klassen, Calgary (CA)

(73) Assignee: NAIAD COMPANY LTD., Calgary (CA)

(21) Appl. No.: 13/241,077

(22) Filed: Sep. 22, 2011

Related U.S. Application Data
(60) Provisional application No. 61/385,220, filed on Sep. 22, 2010.

(51) Int. Cl. F16L 27/06

(52) U.S. Cl. 285/145.3

(57) ABSTRACT

A pipe connecting system for providing fluid communication between pipes that are offset vertically and/or horizontally is described. The pipe connecting system comprises a first and second pivot attachment system for attaching the pipe connecting system to the pipes; and a telescopically extendable central connector that is pivotably engaged with the first and second pivot attachment systems to enable the central connector to be positioned at various angles with respect to the pivot attachment systems.

### RELATED APPLICATIONS

This application claims the benefit of priority under 35 U.S.C. §119 of U.S. Provisional Patent Application No. 61/385,220 filed Sep. 22, 2010 which is incorporated herein by reference in its entirety.

### FIELD OF THE INVENTION

This application is related to a pipe connecting system for providing fluid communication between pipes and, in particular, for connecting pipes that may be misaligned and/or subject to relative movement therebetween. The pipe connecting system includes a first and second pivot attachment system for attaching the pipe connecting system between the pipes and a telescopically extendable central connector pivotably engaged with the first and second pivot attachment systems to allow the central connector to be positioned at various angles and distances with respect to the pivot attachment systems.

### BACKGROUND OF THE INVENTION

Routinely in a large number of operational situations in the oil and gas industry, (colloquially known as the “oil patch”), it is necessary to connect different sections of piping together. Such systems may require connecting standard-size flanges of the pipe sections to permit both high and low-pressure fluids to be carried within connected pipe sections. Often, when different sections of the pipe must be connected together in the field, the relative alignment between the different sections is offset or misaligned such that significant stress is incorporated into the connection if such pipes are connected together. Moreover, if the degree of misalignment is significant enough, it simply may not be possible to connect the different sections together without a significant custom solution being developed. Further still, in various operational situations, the relative distance between the ends of the different pipe sections may be variable and may change due to a variety of factors including temperature variations and/or the support systems for the pipe sections.

As a result, there has been a need for pipe connection systems that readily allow field workers to connect different pipe sections together that may be misaligned and separated from one another and that are otherwise capable of carrying normal oil patch fluids including high-pressure and high-temperature fluids.

As an example of the complexity and hence cost of prior art methods of addressing the above problems, a method in use today is to measure the distance between the two ends of pipe that must be in sealed communication and to cut a proper length of pipe to fit there between. Thereafter, field workers position the pipe into its ultimate position, fit proper flanges and tack weld these connecting flanges to the center piece of pipe. Once measured, the pipe is put on a bench and welded together by hand. Thereafter, it is usually common practice to send this welded unit to an oven for stress relief to relieve any internal stresses which may have formed during the welding process. Furthermore, it is common practice to bathe this custom piece in an acid bath to remove slag and other types of debris which may have formed thereon, in particular from the weld. Finally, the unit may have to be pressure tested before actually connecting the custom unit to the final pipe. Pressure testing typically requires fitting the piece to a pressure testing system that applies the requisite pressures for its end use. After these processes, if the unit does not fit or fails a test for whatever reason, it must be re-fabricated and all of the above steps must be re-done. As can be readily understood, such a process involves a significant amount of skilled construction, processing and fabrication time as well as supplies of construction and fabrication materials, all of which significantly affect the costs and time involved in assembly and/or servicing a job.

Thus, the conventional process for fitting two ends of pipe together can be expensive, utilize many man-hours and require a large amount of downtime before completion of a job. Finally, it should be noted that in many oil patch jobs, the location of a job may be in a remote location that also contributes to the time and cost in completing a job.

While the prior art teaches various connecting systems that provide a solution to various aspects of the above problems, there continues to be a need for pipe connecting systems that minimize the time and complexity of effecting pipe connections in the field and in particular, for effecting pipe connections involving high pressure fluids.

### SUMMARY OF THE INVENTION

In accordance with the invention, there is provided a pipe connecting assembly for providing fluid communication between pipes.

Specifically, there is provided a pipe connecting assembly for interconnecting a first pipe and a second pipe, the pipe connecting assembly having an interior surface defining a fluid passageway, the pipe connecting assembly comprising a first pivot attachment system for operative and fluid connection to the first pipe, the first pivot attachment system having a first socket; a first sleeve having a first ball operatively retained within the first socket; and a second sleeve telescopically engaged with the first sleeve, the second sleeve including a second sleeve connection system for connection to the second pipe; wherein the second sleeve includes at least one sealing element in sealing contact with the first sleeve and second sleeve, the sealing element moveable with respect to the first sleeve during telescopic extension of the first sleeve with respect to the second sleeve.

In one embodiment, the second sleeve connection system includes a second ball for operative connection to a second pivot attachment system having a second socket.

In another embodiment, the first socket includes a first socket seal adjacent the interface between the first ball and first socket. Preferably the first socket seal includes a first socket recess operatively retaining a first socket o-ring.

In yet another embodiment, the at least one sealing element includes at least one second sleeve recess operatively retaining at least one second sleeve o-ring.

In another embodiment, the first pivot attachment system includes a first housing member for connection to the first pipe and a first housing cover for connection to the first housing member, the first housing member and first housing cover having dimensions to permit insertion and sealing retention of the first ball within the first socket.

In a further embodiment, there is provided a pipe connection assembly further comprising an outer sleeve having a first end operatively connected to the first sleeve and telescopically connected to the second sleeve for exterior sealing of the second sleeve and exterior protection of the second sleeve. Preferably, the second sleeve includes a shoulder and the assembly further comprises a retaining ring operatively connected to a second end of the outer sleeve, the retaining ring having an internal diameter for operative engagement with the shoulder to prevent separation of the first sleeve with respect to the second sleeve. In one embodiment the retaining ring includes a retaining ring seal between the retaining ring and second sleeve.

In yet another embodiment, the first sleeve of the pipe connection assembly is pivotable with respect to the first pivot attachment system. Preferably, the first sleeve is pivotable to an angle up to 15° in all directions with respect to the longitudinal axis of the first pivot attachment system.

In one embodiment, the first sleeve is rotatable 360° about the longitudinal axis of the first pivot attachment system.

In another embodiment, the first socket and first ball define a ball/socket fluid passageway substantially continuous between the first sleeve and first pivot attachment system during pivotable movement of the first sleeve with respect to the first pivot attachment system. Preferably, the first ball includes a frusto-conical recess at the first ball/socket fluid passageway.

In yet another embodiment, the pipe connecting assembly passes a standard ASME hydrostatic pressure test of 22,960 kPag for 60 minutes at a temperature of 15 to 30° C.

### BRIEF DESCRIPTION OF THE DRAWINGS

The invention is described with reference to the accompanying figures in which:

FIG. 1 is an isometric view of an installed connecting member in accordance with one embodiment of the invention;

FIG. 2 is a side view of the connecting member in accordance with one embodiment of the invention;

FIG. 3 shows the connecting member in a pre-installation position in a typical operating environment in accordance with one embodiment of the invention;

FIG. 4 is a partial sectional view of the connecting member showing the ball and socket joints and the plurality of sealing systems in accordance with one embodiment of the invention;

FIG. 5 is an isometric view of the connecting member showing the flange regions in accordance with one embodiment of the invention;

FIG. 6A is a side profile view of the connecting member in a typical installation illustrating a possible angle of reorientation of the end regions with respect to the central region in accordance with one embodiment of the invention;

FIG. 6B is a cross-sectional view of the connecting member in a typical installation wherein the shoulder regions are at an angle with respect to the central region in accordance with one embodiment of the invention;

FIG. 7 is an exploded view of the connecting member in accordance with one embodiment of the invention;

FIG. 8 is an exploded view of the flange region in accordance with one embodiment of the invention;

FIG. 9A is a side view of the connecting member showing the telescopic central connector in an extended position; and

FIG. 9B is a side view of the connecting member showing the telescopic central connector in a non-extended position.

### DETAILED DESCRIPTION OF THE INVENTION

### Overview

With reference to the figures, a pipe connecting system 20 for interconnecting two pipes is described. The system is particularly intended for use in the oil and gas industry, where it may be necessary to connect two offset pipes potentially containing high pressure and high temperature fluids effectively and efficiently.

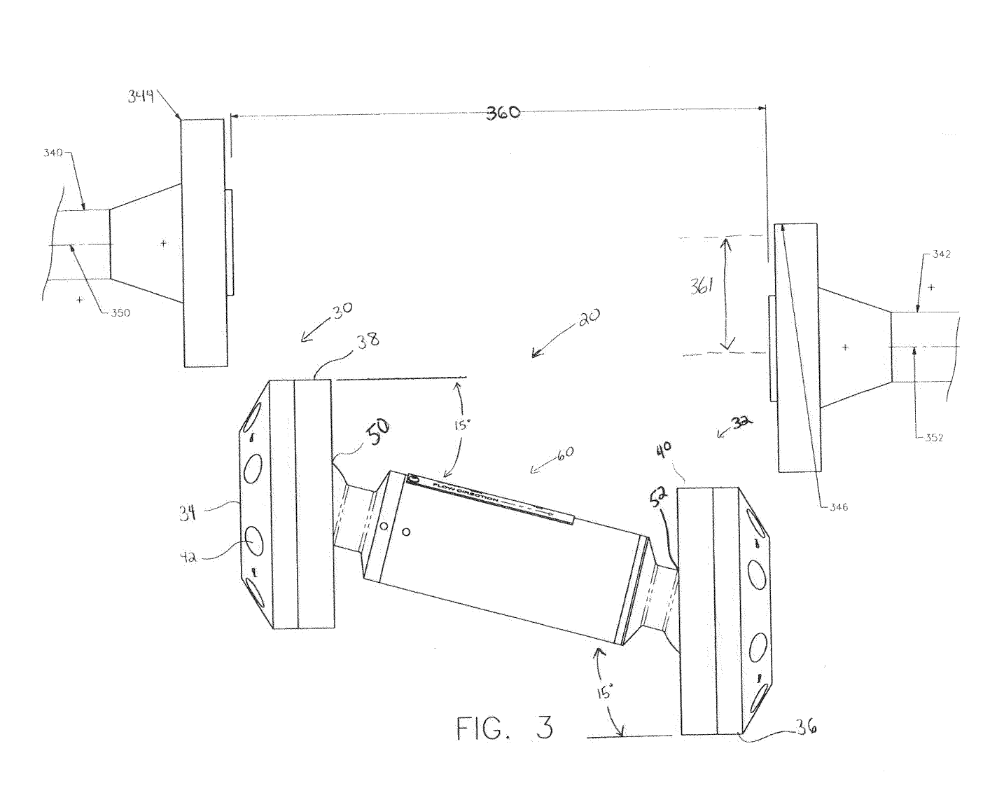

As shown in FIG. 3, the pipe connecting system 20 is used to connect a first and second pipe 340, 342 having flanges 344, 346 that may be potentially horizontally 360 and/or vertically 361 offset with respect to one another. The pipe connecting system allows for spherical articulation at either end of the system in order to connect the offset pipes.

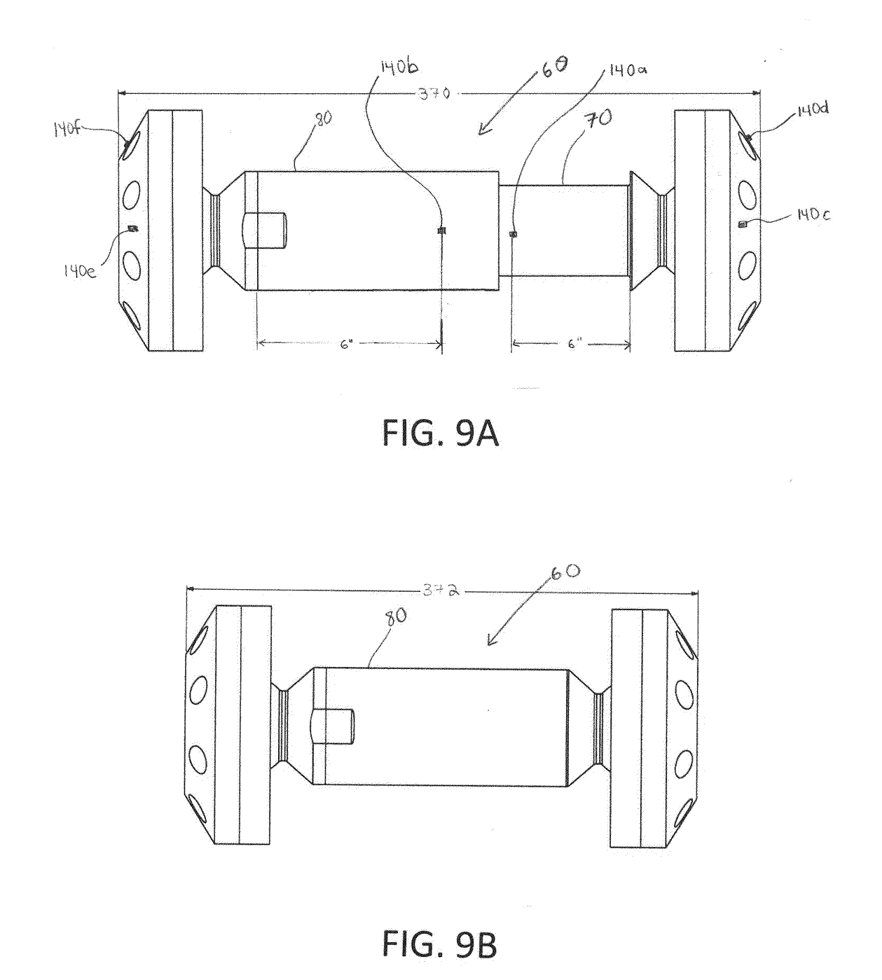

As best shown in FIGS. 9A and 9B, the pipe connecting system 20 is telescopically extendable to various lengths to accommodate varying distances between the first and second pipe.

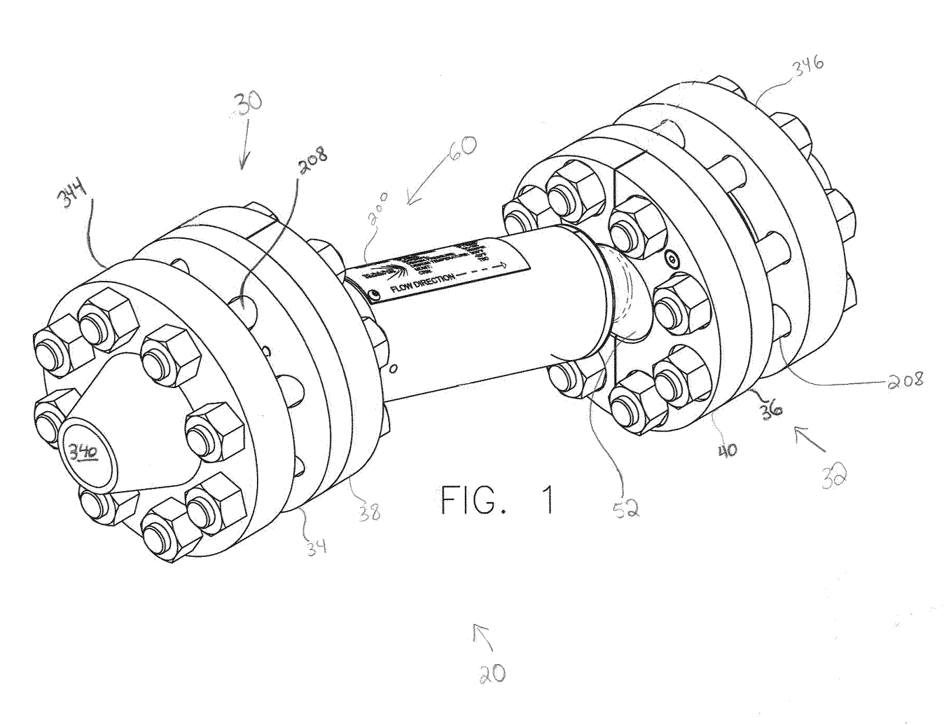

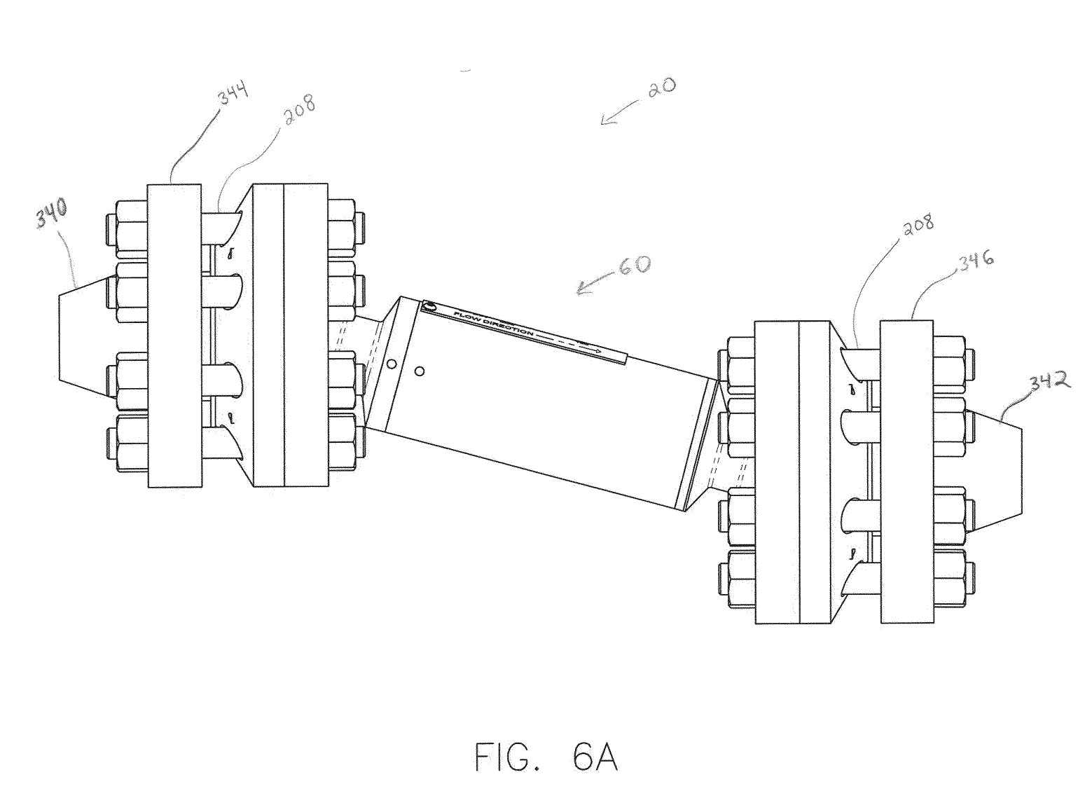

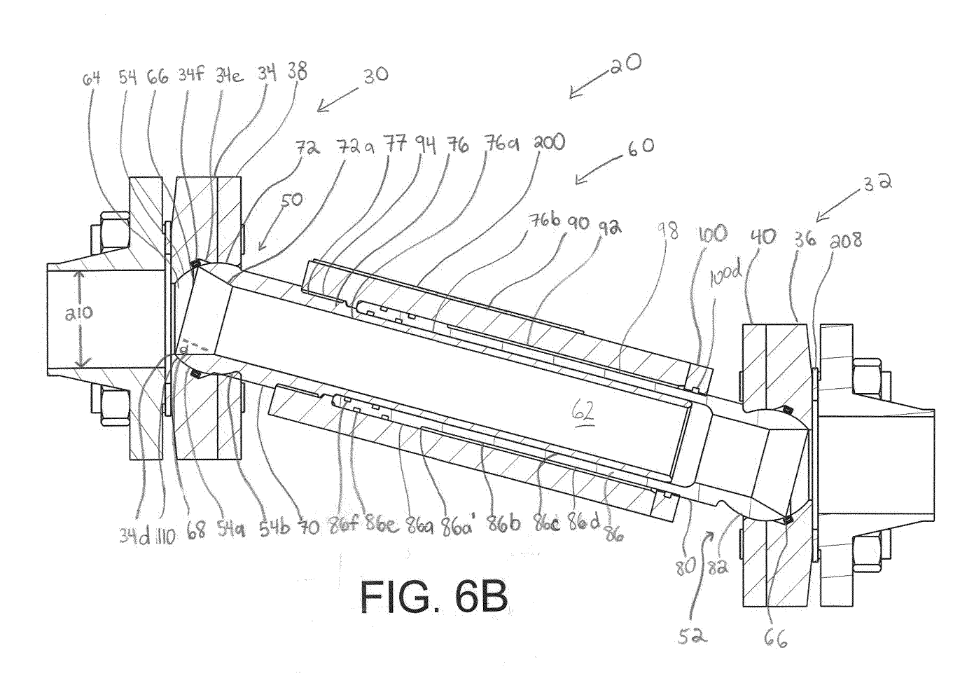

As shown in FIG. 1, the pipe connecting system 20 generally includes first and second pivot attachment systems 30, 32 and a telescopic central connector 60. The first and second pivot attachment systems 30, 32 generally each include first and second housing members 34, 36 and first and a second detachable covers 38, 40. In operation, housing members 34, 36 are attached to the first and second pipe flanges 344, 346 respectively as will be explained in greater detail below. The detachable covers 38, 40 are connected to the central connector 60 with first and second ball-and-socket joints 50, 52 as shown in FIG. 6B.

Referring again to FIG. 6B, the central connector 60 generally includes a first connecting member 70, a second connecting member 80, an outer sleeve 90 and a retaining member 100. The inner surfaces of the central connector 60 create a fluid passageway 62 through which fluid from the first pipe 340 is conveyed to the second pipe 342.

The design and functions of each component of the pipe connecting system 20 are described in greater detail below.

### Telescopic Central Connector

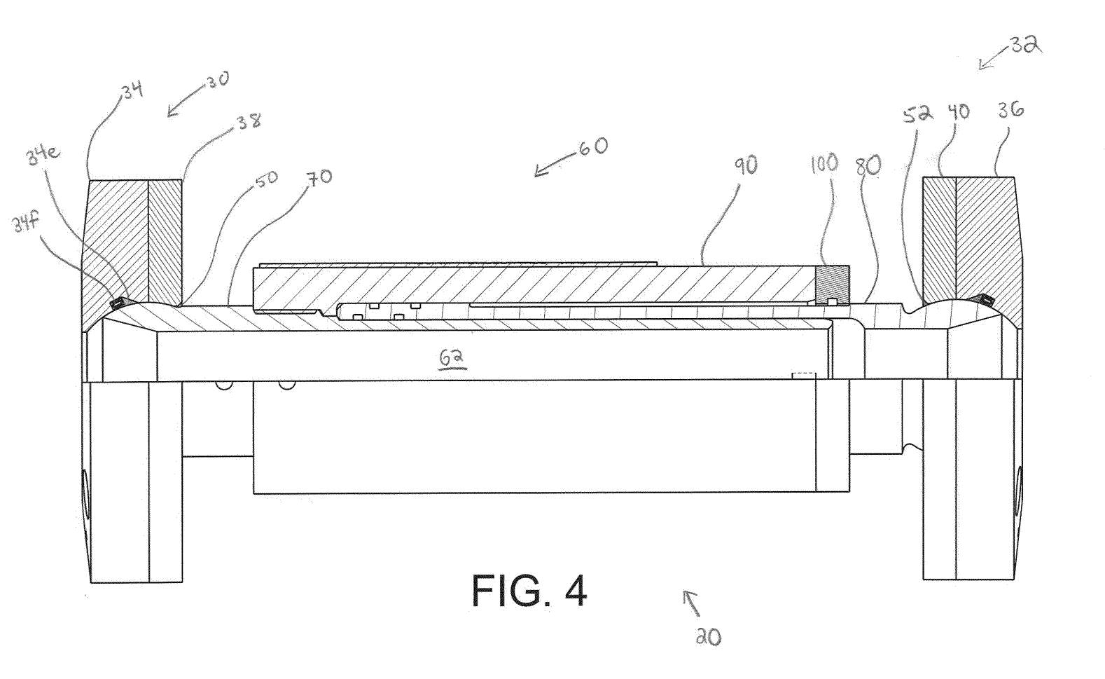

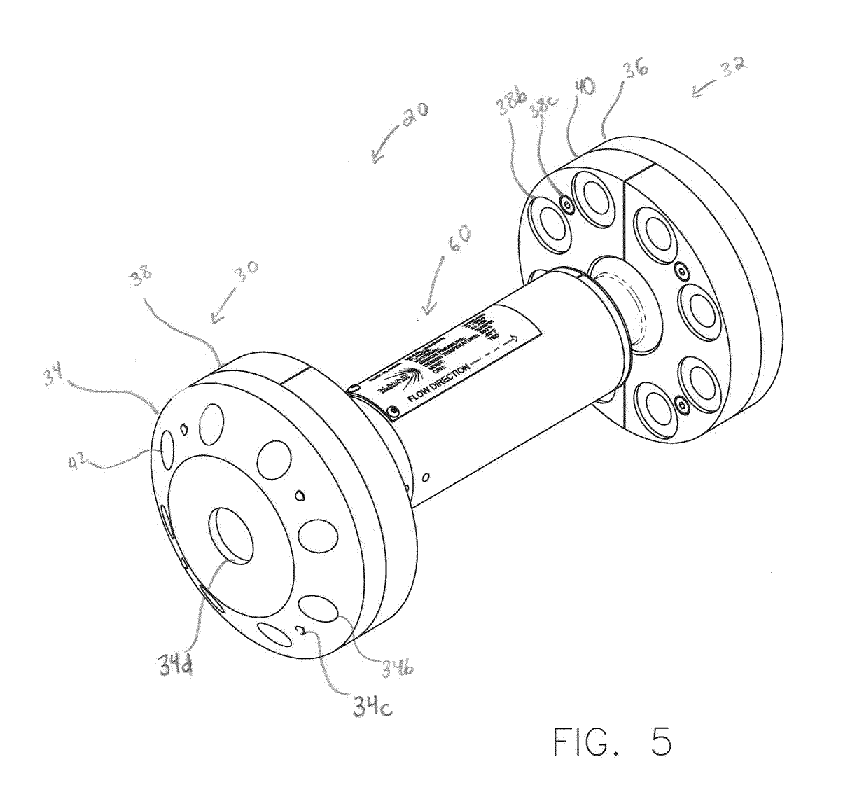

With reference to FIGS. 4, 6B and FIG. 7, the first connecting member 70 includes ball head 72, central sleeve 76 and exterior buttress threads 77. The tube 76 has an inner surface 76a and an outer surface 76b, wherein the inner surface 76a forms the exterior of the fluid passageway 62.

Similarly, the second connecting member 80 includes a second ball head 82 and second sleeve 86. The second sleeve 86 has a first end 86a, a neck 86b, an inner surface 86c and an outer surface 86d. The inner surface 86c is slidingly engaged with the first connecting member outer surface 76b such that the first connecting member is telescopically displaceable within the second connecting member.

The outer sleeve 90 has an inner surface 92 with interior buttress threads 94, whereby the interior buttress threads 94 engage with the exterior buttress threads 77 of the first connecting member 70. The outer surface 76b of the first connecting member tube and the inner surface 92 of the outer sleeve 90 form a cavity 98 for receiving second connecting member sleeve 86. The outer sleeve adds extra strength to the connecting member and facilitates the sliding movement of the second connecting member.

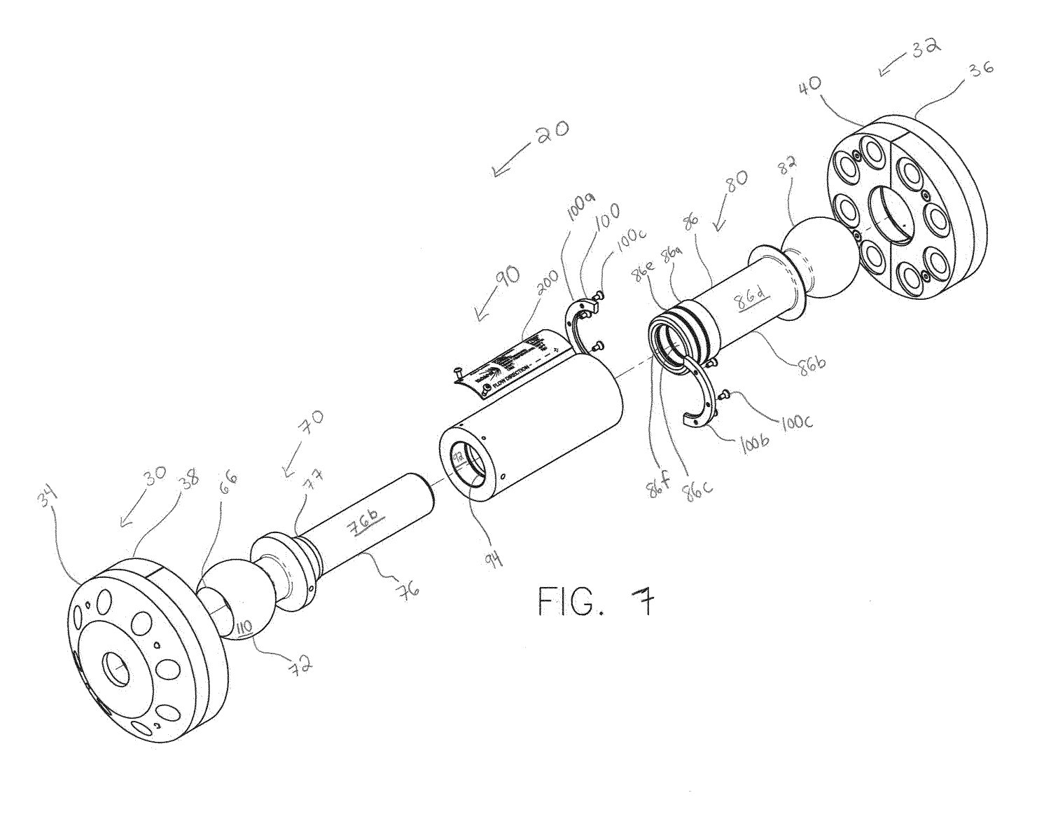

As shown in FIG. 6B, retaining member 100 is attached to the end of the outer sleeve 90 to prevent the second connecting member 80 from being removed completely from the cavity 98. As shown in FIG. 7, the retaining member 100 is preferably comprised of sections 100a, 100b that are secured to the outer sleeve with fastening means 100c, such as bolts, screws or the like. The retaining member 100 is sized to engage with a shoulder 86a′ of first end 86a in a fully extended position so as to prevent separation of the first sleeve from the second sleeve.

Various sealing mechanisms are in place to prevent pressurized fluid in the fluid passageway 62 from leaking from the pipe connecting system 20. The outer surface 86d and the inner surface 86c of the second sleeve 86 have annular recesses 86e, 86f. Sealing mechanisms, such as O-rings, are located within the annular recesses to create a tight hydraulic seal between the first sleeve 70, the second sleeve 80 and the outer sleeve 90. The retaining member 100 also has an annular recess 100d to accommodate a sealing mechanism, such as an O-ring, to create a hydraulic seal between the retaining member and the second connecting member 80. While not essential in all embodiments, it is preferred that redundancy in the number of o-rings at the various interfaces is provided.

### Pivot Attachment System

The pivot attachment systems 30, 32 enable the ends of the central connector 60 to pivot spherically around the pivot attachment systems in order to align the pipe connecting system 20 with the first and second pipe 340 and 342 and to allow for movement within the pipe connecting system as further described below. The pivot attachment systems are substantially identical, and as such, the first pivot attachment system 30 will be described in detail with the understanding that the same description applies to the second pivot attachment system 32.

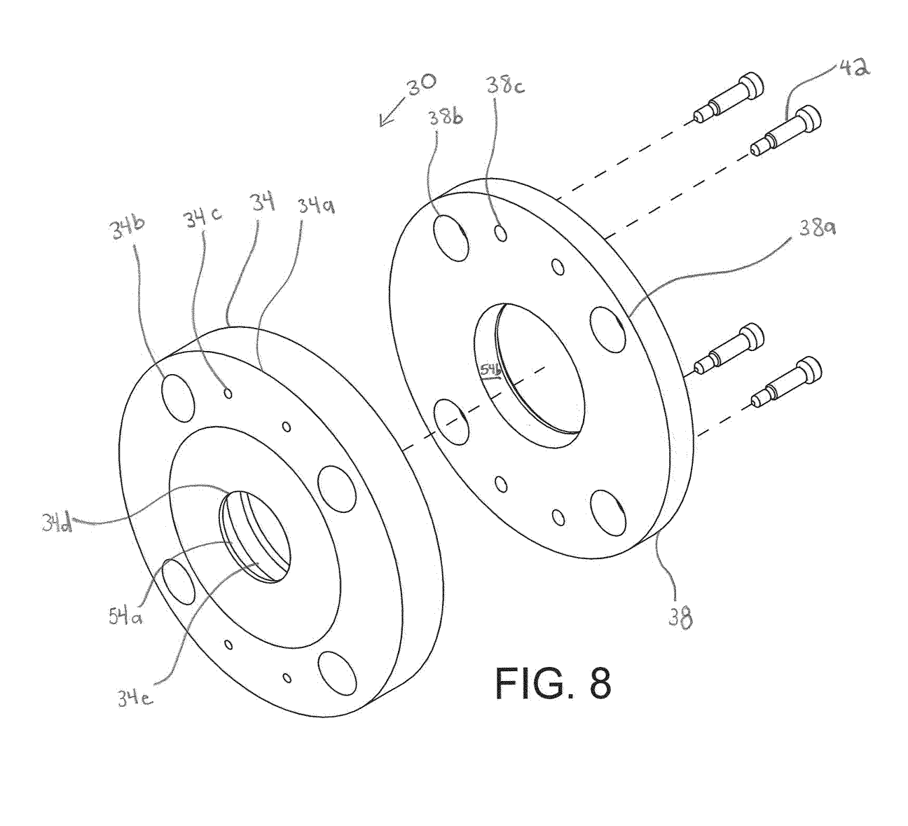

As shown in the figures and outlined above, the pivot attachment system 30 includes housing member 34 and the detachable cover 38. Referring to FIGS. 7 and 8, the housing member 34 has a rim region 34a that includes a first set of apertures 34b and a second set of apertures 34c. The first set of apertures 34b are preferably configured to be common in the industry and positioned to engage corresponding apertures of flange member 344 as best shown in FIGS. 1, 6A and 6B of the first pipe 340. FIGS. 1, 6A and 6B also illustrate the housing member 34 attached to the flange member 344 of the first pipe using bolts 208.

Referring back to FIG. 8, the second set of apertures 34c of the housing member 34 are configured to secure the detachable cover 38 to the housing member 34 using fastening means 42 such as bolts, screws or the like. The rim region 34a of the housing member further defines an inner opening 34d allowing fluid to pass therethrough and which forms part of the fluid passageway 62. In the preferred form, as shown in FIG. 6B, the diameter of the inner opening 34d is the same or substantially similar to the inner diameter 210 of the first pipe 340.

As shown in FIG. 4 and FIG. 6B, proximal to the inner opening 34d, the inner surface of the housing member 34 forms, in part, a spherical surface 54a that is part of a socket 54 of the ball-and-socket joint 50. The ball-and-socket joint will be discussed in greater detail below.

Referring to FIG. 8, the detachable cover 38 is similar in structure and function to the housing member 34 in that the detachable cover 38 is comprised of a rim region 38a, a first set of apertures 38b and a second set of apertures 38c. The inner surface 54b of the detachable cover is spherical and, along with the spherical inner surface 54a of the housing member, forms the socket 54. When the housing member 34 and detachable cover are secured together, the ball head 72 of the first connecting member is secured in the socket 54.

As shown in FIG. 6B, there is an annular groove 34e along the interior surface 54a of the housing member 34 that extends circumferentially around the socket 54. A seal 34f fits in the annular groove to create a pressure seal between the housing member 34 and the socket 54.

The pivot attachment system has been described herein as having two sections, the housing member 34 and the detachable cover 38. However, as known to those skilled in the art, the pivot attachment system may be comprised of a variety of number of sections or may be a unitary member.

### The Ball-and-Socket Joint

The first and second ball-and-socket joints 50, 52 are substantially identical, and as such, the first ball-and-socket joint 50 will be described in detail with the understanding that the same description applies to the second ball-and-socket joint 52.

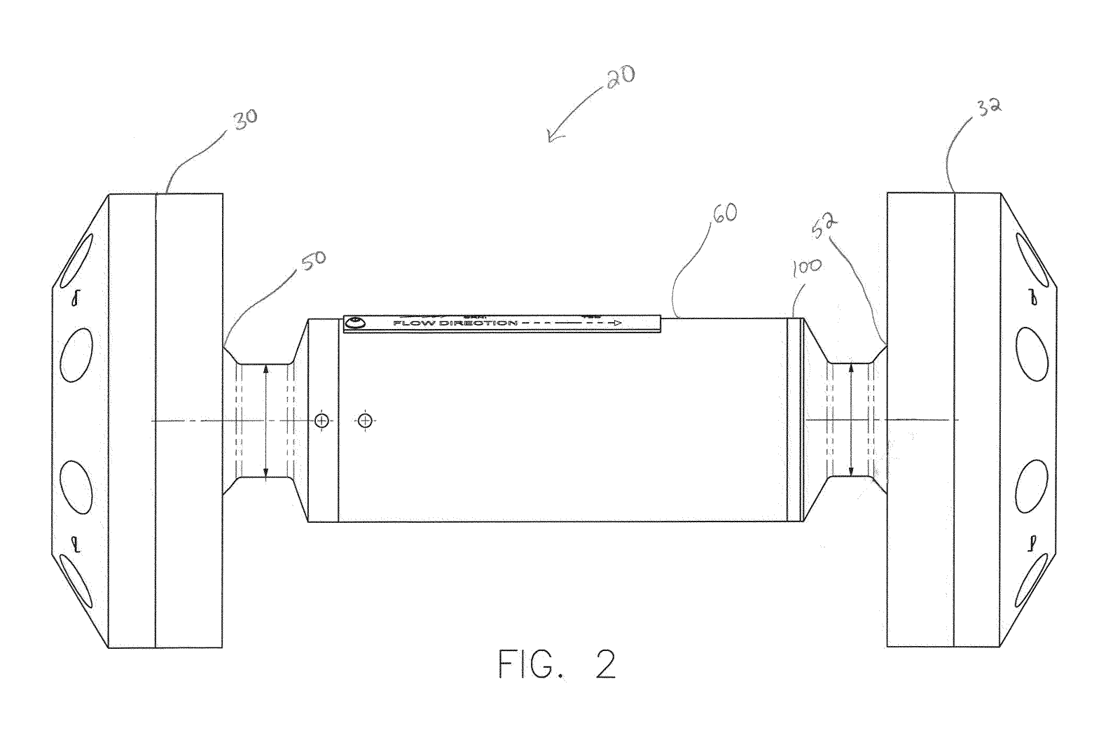

As shown in FIG. 6B, the side view shows how the pivot attachment system 30 and the central connector 60 are connected via the ball-and-socket joint 50. The socket 54 is formed by the inner spherical surfaces 54a, 54b of the housing member 36 and detachable cover 38 of the pivot attachment system 30. The ball head 72 is part of the central connector 60. The ball head 72 is partially spherical and fits within the socket 54. The ball-and-socket joint enables the ball head of the central connector to rotate axially and pivot within the socket. FIG. 6B shows the central connector positioned at a pivot limit, while FIG. 2 illustrates a perpendicular orientation. Generally the central connector can pivot a maximum of 15 degrees in any direction.

The connection between the central connector and the pivot attachment system has been described herein as comprising a ball-and-socket joint. However, as known to those skilled in the art, a variety of joint types could be used to connect the members.

### Fluid Passageway

As shown in FIG. 6B, the fluid passageway 62 through the pipe connecting system 20 is comprised of the inner opening 34d of the first housing member 34, the inner surface 76a of the first connecting member 70, at least part of the inner surface of the second connecting member 80, and an inner opening 36d of the second housing member 36. In the preferred form, referring to FIG. 6B, the fluid flows from the left side of the pipe connecting system 20 to the right, as illustrated by the flow direction label 200. In the preferred form, the fluid passageway 62 is cylindrical or substantially cylindrical, with the exception of the interior surfaces of the ball heads 72, 82 of the first and second connecting members.

As noted previously, the outer surface of the ball head is adapted to engage the seal 34e in order to create a fluid seal between the ball head and the pivot attachment system. The ball head has outer lips 66 that generally do not extend inwardly past the seal 34f. The ball head 72 comprises an inner surface 72a that forms part of the fluid passageway 62. In general, the distal portion of the inner surface 72a is at least partially frusto-conical, with the wider end of the frustocone being adjacent the outer lips 66 of the ball head 72. The frusto-conical inner surface, which is shown cross-sectionally in FIG. 6B, forms an angle 68 which is less than or equal to the maximum angle of displacement of the central connector 60 with respect to the pivot attachment system 30 so the flow of the fluid through the fluid passageway does not directly strike an area 110 that is adjacent the outer lip 66 so as to reduce internal fluid turbulence.

In other words, the outer lip 66 of the ball head has a diameter that when the central connector 60 is positioned at an extreme angle (FIG. 6B), fluid (which is compressible or incompressible) flowing through the fluid passageway 62 will enter the chamber region 64 of the ball-and-socket joint without, as mentioned above, directly striking the area 110 adjacent the outer lip.

### Working Environment

FIG. 3 shows a schematic view of an operating environment where the pipe connecting system 20 can be implemented. In general, the first piping fixture 340 is in somewhat of an approximate location to the second pipe 342. As noted above, the first and second pipes, in general, are fitted with flange members 344 and 346 which can be connected to the first and second pivot attachment systems 30, 32. As known to those skilled in the art, flange-like members for connecting portions of pipe are common in the oil and gas sector, however a variety of attachment-like mechanisms can be implemented.

The first pipe 340, which presumably has an interior cylindrical bore, has a central axis 350, and the second pipe fixture 342 has a central axis 352. Oftentimes when connecting pipes, the axes 350 and 352 are not co-linear. Further, the central axes may be offset from one another, or may be offset and non-intersecting. One of the pipes 340 or 342 may be attached to some form of mechanism, such as a pump or compressor, which can cause vibration. Further, depending upon the length of the material and various factors, thermal expansion/contraction can occur, changing the distance 360 between the pipes and also changing the relationship between the axes 350 and 352 of the pipes.

For example, if the first pipe 340 is attached to a series of elbows (90-degree fittings), thermal deflection can displace the axis 350 in a direction other than the alignment of the axes 350 (for example, orthogonal thereto if there is an orthogonal pipe fitting somewhere removed from the terminating end of the pipe 340). Therefore, it can be appreciated that in connecting the pipes 340 and 342, the installer must consider the immediate orientation of the central axes 350 and 352 (and, practically speaking, the installer may utilize the flange portions 344 and 346, which is the point of connection).

Further, in certain circumstances it may be desirable to allow the pipe fixtures 340 and 342 to allow for a certain amount of flexion there between, as well as attempt to isolate vibrations there between. Therefore, it can be appreciated in particular with the detailed foregoing description above, that the operation of the pivot connecting system 20 is such that the pivot attachment systems 30, 32 (such as those shown in FIG. 1) can be reoriented with respect to the central connector 60 to accommodate the orientations of the axes 350 and 352, or to be co-linear therewith, depending on field conditions. Generally, each pivot attachment system allows for spherical 15° articulation as shown in FIG. 3.

The telescopic central connector 60 allows for longitudinal changes in the distance between the first and second pivot attachment system 30, 32. This change in distance allows for adjustment of the length of the pipe connecting system in order to fit the pipe connecting system between the pipe fixtures 340 and 342. FIG. 9A illustrates the telescopic central connector in an extended position wherein the pipe connecting system has a maximum length 370. FIG. 9B illustrates the telescopic central connector in a non-extended position wherein the pipe connecting system has a minimum length 372. Preferably, the maximum length of the pipe connecting system is approximately 58 cm (23 inches) and the minimum length is approximately 46 cm (approximately 18 inches).

The central connector also allows for a certain amount of fine displacement between the first and second connecting members 70 and 80 when the pipe connecting system is connected to the first and second pipe. For example, in the broader range the motion between the telescopic members can be approximately 0 mm-20 mm. A more preferred range is a prescribed amount of motion of about 0 mm-5 mm given the common forces that are exerted upon the unit in the field. The motion is generally high frequency low amplitude and can be oscillatory-type motion which aids in dampening vibrations. Or, the motion can be, for example, a thermal expansion of one of the pipes 340 or 342 where the central connector will absorb a certain amount of the deflection. Of course, it should further be noted that the ball and joint system can also allow for a certain amount of deflection of the pipe fixtures 340 and 342. In other words, various angles in the pipe such as right angles to the axis 350 as shown in FIG. 3 can cause a certain amount of displacement of the axis 350 with respect to the axis 352. This displacement can occur in essentially any six of the forms of movement (movement in either of the orthogonal directions or rotation about the various directions). The ball and joint arrangement of the pipe connecting system 20 is well suited to handle such reorientation in the field.

Further, the various sealing assemblies as described in great detail above between the ball and joint mechanisms as well as the telescopic extending members maintains a seal for transmittal of fluid (whether compressible or incompressible) there through.

The pipe connecting system preferably accommodates an internal working pressure of 1950 psig. The working fluid is preferably natural gas, however the working fluid may be other gases or liquids.

The pipe connecting member is preferably made from a high strength steel and may be coated to increase corrosion resistance.

### Testing

### Testing Protocol

Testing was performed on the pipe connecting system to confirm the integrity of the design under a representative set of operating conditions, which included static and dynamic forces, and to confirm that the system was absolutely free of leaks and maintained relative movements of the flange and sliding joint components. The testing was performed with the outer sleeve removed.

Three types of tests were performed: a hydrostatic test; a static maximum allowable working pressure (MAWP) test; and a vibration test. The testing fluid was kept static inside the system at the prescribed pressure.

The primary pass/fail criterion for all the test scenarios was the evidence of leakage. The second pass/fail criterion was material failure, including deformation, breakage, failure or cracking of the system.

The system was tested under three test temperatures: ambient (15-30° C.), cold (−30° C.); and hot (150° C.). For all tests, the system and the internal test fluid were maintained at the prescribed test temperature (+/−5° C.) throughout the test, with the filled unit allowed to “soak” prior to testing until it reached the specified temperature.

Six 3-direction rosette strain gauges 140a, 140b, 140c, 140d, 140e, 140f were placed on the unit to measure axial and hoop strains as shown in FIG. 9A. Strain gauges 140c and 140e were located in line with the split of the split flange of the detachable covers 38, 40, and strain gauges 140d and 140e were located approximately 90° from the split. Strain gauge measurements were taken for the hydrostatic and MAWP test.

For the hydrostatic test, the system was subjected to a standard ASME (American Society of Mechanical Engineers) hydrostatic pressure test of 22 960 kPag (+/−75 kPa) for a duration of 60 minutes at ambient temperature.

Following the completion of the hydrostatic test, the system was subjected to the static MAWP test where there was a succession of decreasing static pressures at various temperatures as shown in Table 1, with the strain gauges in recording mode.

TABLE 1
Pressure testing protocol for the static MAWP test.

| Test Temperature | Internal Test | |
|---|---|---|
| (° C.) | Pressure (kPag) | Hold Time (hours) |
| 150 | 15300 | 20 |
| 150 | 3800 | 1 |
| 150 | 1500 | 1 |
| Ambient | 15300 | 4 |
| Ambient | 3800 | 2 |
| Ambient | 1500 | 2 |
| −30 | 12900 | 2 |
| From −30 to +15 | 15300 | As required to warm |
| | | up across |
| | | temperature range |

For the vibration test, the system was instrumented with the addition of an externally-applied mechanical vibration having an amplitude of 10 mils peak-to-peak at a constant frequency of 20 Hz +/−2 Hz, applied in both an axial and radial direction. The system was tested with one end fixed and the other end attached to a vibration-inducing mechanism, and the system was subjected to a succession of decreasing static pressures at various temperatures as shown in Table 2.

TABLE 2
Testing protocol for the vibration test.

| Test Temperature | Internal Test | |
|---|---|---|
| (° C.) | Pressure (kPag) | Hold Time (hours) |
| 150 | 15300 | 6 |
| 150 | 3800 | 2 |
| Ambient | 15300 | 2 |
| Ambient | 3800 | 2 |

### Testing Results

The pipe connecting system passed all the tests in that neither leakage nor material failure was evident.

Although the present invention has been described and illustrated with respect to preferred embodiments and preferred uses thereof, it is not to be so limited since modifications and changes can be made therein which are within the full, intended scope of the invention as understood by those skilled in the art.

1. A pipe connecting assembly for interconnecting a first pipe and a second pipe, the pipe connecting assembly having an interior surface defining a fluid passageway, the pipe connecting assembly comprising:
a first pivot attachment system for operative and fluid connection to the first pipe, the first pivot attachment system having a first socket;
a first sleeve having a first ball operatively retained within the first socket; and
a second sleeve telescopically engaged with the first sleeve, the second sleeve including a second sleeve connection system for connection to the second pipe;
wherein the second sleeve includes at least one sealing element in sealing contact with the first sleeve and second sleeve, the sealing element moveable with respect to the first sleeve during telescopic extension of the first sleeve with respect to the second sleeve.

2. The pipe connecting assembly of claim 1 wherein the second sleeve connection system includes a second ball for operative connection to a second pivot attachment system having a second socket.

3. The pipe connecting assembly of claim 1 wherein the first socket includes a first socket seal adjacent the interface between the first ball and first socket.

4. The pipe connecting assembly of claim 3 wherein first socket seal includes a first socket recess operatively retaining a first socket o-ring.

5. The pipe connecting assembly of claim 1 wherein the at least one sealing element includes at least one second sleeve recess operatively retaining at least one second sleeve o-ring.

6. The pipe connecting assembly as in claim 1 wherein the first pivot attachment system includes a first housing member for connection to the first pipe and a first housing cover for connection to the first housing member, the first housing member and first housing cover having dimensions to permit insertion and sealing retention of the first ball within the first socket.

7. The pipe connection assembly as in claim 1 further comprising an outer sleeve having a first end operatively connected to the first sleeve and telescopically connected to the second sleeve for exterior sealing of the second sleeve and exterior protection of the second sleeve.

8. The pipe connection assembly as in claim 7 wherein the second sleeve includes a shoulder and the assembly further comprising a retaining ring operatively connected to a second end of the outer sleeve, the retaining ring having an internal diameter for operative engagement with the shoulder to prevent separation of the first sleeve with respect to the second sleeve.

9. The pipe connection assembly as in claim 8 wherein the retaining ring includes a retaining ring seal between the retaining ring and second sleeve.

10. The pipe connection assembly as in claim 1 wherein the first sleeve is pivotable with respect to the first pivot attachment system.

11. The pipe connecting assembly of claim 1 wherein the first sleeve is rotatable 360° about the longitudinal axis of the first pivot attachment system.

12. The pipe connecting assembly of claim 10 wherein the first sleeve is pivotable to an angle up to 15° in all directions with respect to the longitudinal axis of the first pivot attachment system.

13. The pipe connecting assembly of claim 1 wherein the first socket and first ball define a ball/socket fluid passageway substantially continuous between the first sleeve and first pivot attachment system during pivotable movement of the first sleeve with respect to the first pivot attachment system.

14. The pipe connecting assembly of claim 13 wherein the first ball includes a frusto-conical recess at the first ball/socket fluid passageway.

15. The pipe connecting assembly of claim 1 that passes a standard ASME hydrostatic pressure test of 22,960 kPag for 60 minutes at a temperature of 15 to 30° C.

16. A pipe connecting assembly for interconnecting a first pipe and a second pipe, the pipe connecting assembly having an interior surface defining a fluid passageway, the pipe connecting assembly comprising:
a first pivot attachment system for operative and fluid connection to the first pipe, the first pivot attachment system having a first socket;
a first sleeve having a first ball operatively retained within the first socket and including a first socket seal;
a second sleeve telescopically engaged with the first sleeve, the second sleeve including a second ball for operative connection to a second pivot attachment system having a second socket for operative and fluid connection to the second pipe;
wherein the second sleeve includes at least one sealing element in sealing contact with the first sleeve and second sleeve, the sealing element moveable with respect to the first sleeve during telescopic extension of the first sleeve with respect to the second sleeve.

17. The pipe connecting assembly as in claim 16 wherein the first pivot attachment system includes a first housing member for connection to the first pipe and a first housing cover for connection to the first housing member, the first housing member and first housing cover having dimensions to permit insertion and sealing retention of the first ball within the first socket.

18. The pipe connection assembly as in claim 17 further comprising an outer sleeve having a first end operatively connected to the first sleeve and telescopically connected to the second sleeve for exterior sealing of the second sleeve and exterior protection of the second sleeve.

19. The pipe connection assembly as in claim 18 wherein the second sleeve includes a shoulder and the assembly further comprising a retaining ring operatively connected to a second end of the outer sleeve, the retaining ring having an internal diameter for operative engagement with the shoulder to prevent separation of the first sleeve with respect to the second sleeve.

20. The pipe connection assembly as in claim 19 wherein the retaining ring includes a retaining ring seal between the retaining ring and second sleeve.

21. The pipe connecting assembly of claim 20 wherein the first socket and first ball define a ball/socket fluid passageway substantially continuous between the first sleeve and first pivot attachment system during pivotable movement of the first sleeve with respect to the first pivot attachment system.

22. The pipe connecting assembly of claim 21 wherein the first ball includes a frusto-conical recess at the first ball/socket fluid passageway.
